(19) United States
(12) Patent Application Publication
(10) Pub. No.: US 2014/0043859 A1
(43) Pub. Date: Feb. 13, 2014

(54) LIGHT GUIDE PLATE AND MANUFACTURING METHOD OF THE SAME

(71) Applicant: SAMSUNG DISPLAY CO., LTD., Yongin-city (KR)

(72) Inventors: Suk Man YANG, Seoul (KR); Jong-Seo Lee, Hwaseong-si (KR)

(73) Assignee: Samsung Display Co., Ltd., Yongin-city (KR)

(21) Appl. No.: 13/706,890

(22) Filed: Dec. 6, 2012

(30) Foreign Application Priority Data
Aug. 8, 2012 (KR) 10-2012-0086951

(51) Int. Cl. F21V 8/00

(52) U.S. Cl. CPC G02B 6/0011
USPC 362/623; 216/44

(57) ABSTRACT

A light guide for converting a dot light source or a linear light source into a planar light source, and the light guide includes a light emitting surface and a reflection surface facing the light emitting surface and having a plurality of reflection patterns, wherein a width of the reflection patterns is less than 10 μm.

### CROSS-REFERENCE TO RELATED APPLICATION

This application claims priority to and the benefit of Korean Patent Application No. 10-2012-0086951, filed on Aug. 8, 2012, which is hereby incorporated by reference for all purposes as if fully set forth herein.

### BACKGROUND

1. Field

Exemplary embodiments of the present invention relate to a light guide converting a dot light source or a linear light source into a planar light source.

2. Discussion of the Background

In a liquid crystal display which is a passive display device displaying an image by controlling light emitted from a separate light source, a light guide is used to convert a dot light source or a linear light source into a planar light source.

Liquid crystal displays are now widely used as one type of flat panel display. A liquid crystal display has two display panels on which field generating electrodes, such as pixel electrodes and a common electrode, are formed. A liquid crystal layer is interposed between the panels, and a backlight module providing light to the display panel inserted with the liquid crystal layer is further included. In the liquid crystal display, voltages are applied to the field generating electrodes so as to generate an electric field over the liquid crystal layer, and the alignment of liquid crystal molecules of the liquid crystal layer is determined by the electric field. Accordingly, an amount of the emitted light provided from the backlight module is controlled, thereby performing image display. The backlight module includes a light source for emitting the light, a light guide for diffusing the light from the light source to convert into a planar light source, and various compensation films and diffusion films.

Recently, the need for a transparent liquid crystal display that generally looks like transparent glass and can display an image has largely increased. When there is an external light source such as sunlight or lighting, the transparent liquid crystal display displays the image by using the external light source, and when there is no external light source, a backlight unit including a transparent light guide and a light source is required to display the image. However, when using a general light guide, a transparent liquid crystal display is not realized, or moiré interference is generated in the image.

The above information disclosed in this Background section is only for enhancement of understanding of the background of the invention and therefore it contains information that does not form the prior art already known in this country to a person of ordinary skill in the art.

### SUMMARY

Exemplary embodiments of the present invention provide a light guide capable of being applied to a transparent liquid crystal display.

Exemplary embodiments of the present invention also provide a transparent liquid crystal display having a backlight unit without moiré interference.

Additional features of the invention will be set forth in the description which follows, and in part will be apparent in the description, or may be learned by practice of the invention.

An exemplary embodiment of the present invention discloses a light guide including a light emitting surface and a reflection surface facing the light emitting surface and including a plurality of reflection patterns, wherein the width of the reflection patterns is less than 10 μm.

An exemplary embodiment of the present invention also discloses a light guide including a light emitting surface and a reflection surface facing the light emitting surface and having a plurality of reflection patterns, wherein an area of one front cross-section of the reflection pattern is less than 100 μm².

An exemplary embodiment of the present invention also discloses a method of manufacturing a light guide including providing a base plate material dispersed with scattering particles; providing a hard stamp having a plurality of protrusions each having a width of less than 10 μm; forming an imprinting object layer on the base plate material; pressing the hard stamp to an imprinting object layer to form an imprinting shape and hardening the imprinting object layer to form an imprinting mask; and etching the base plate material by using the imprinting mask to form a prism pattern.

It is to be understood that both the foregoing general description and the following detailed description are exemplary and explanatory and are intended to provide further explanation of the invention as claimed.

### BRIEF DESCRIPTION OF THE DRAWINGS

FIG. 1 is a cross-sectional view of a transparent liquid crystal display according to an exemplary embodiment of the present invention.

FIG. 2 is a process view showing a manufacturing method of a light guide according to an exemplary embodiment of the present invention.

FIG. 3 shows an image display screen of a liquid crystal display using a general scattering particle type of light guide and a liquid crystal display using a general prism type of light guide.

FIG. 4 shows an image display screen of a liquid crystal display according to an exemplary embodiment of the present invention.

FIG. 5 is a cross-sectional view of a light guide according to another exemplary embodiment of the present invention.

FIG. 6 is a partial front view of a light guide according to an exemplary embodiment of the present invention.

FIG. 7 is a partial front view of a light guide according to another exemplary embodiment of the present invention.

### DETAILED DESCRIPTION OF THE ILLUSTRATED EMBODIMENTS

The present invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers, films, panels, regions, etc., may be exaggerated for clarity. Like reference numerals in the drawings denote like elements.

It will be understood that when an element such as a layer, film, region, or substrate is referred to as being “on” or “connected to” another element, it can be directly on or directly connected to the other element, or intervening elements may also be present. In contrast, when an element is referred to as being “directly on” or “directly connected to” another element, no intervening elements present. It will be understood that for purposes of this disclosure, “at least one of X, Y, and Z” can be construed as X only, Y only, Z only, or any combination of two or more items X, Y, and Z (e.g., XYZ, XYY, YZ, ZZ).

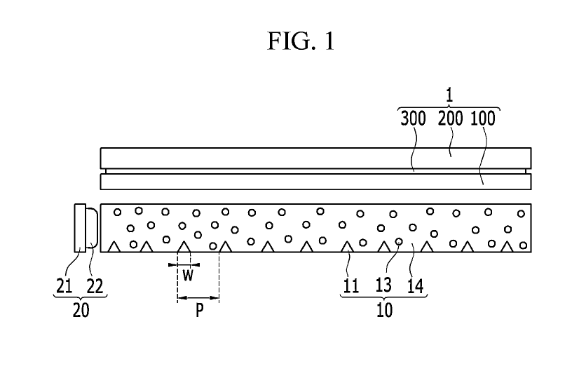

A liquid crystal display according to an exemplary embodiment of the present invention will be described with reference to FIGS. 1, 6, and 7.

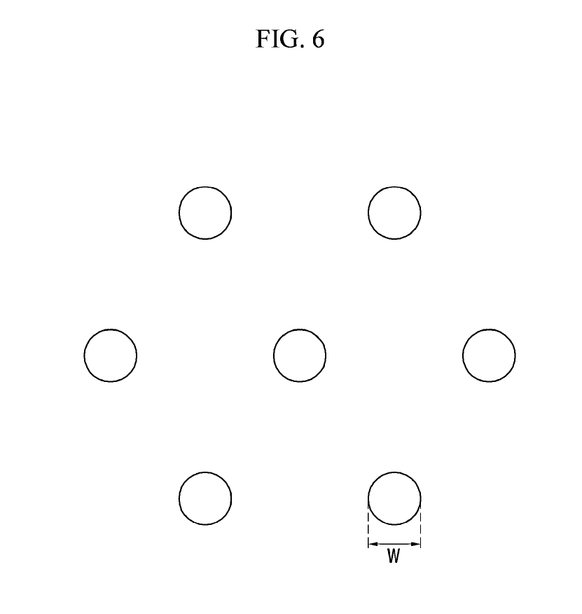

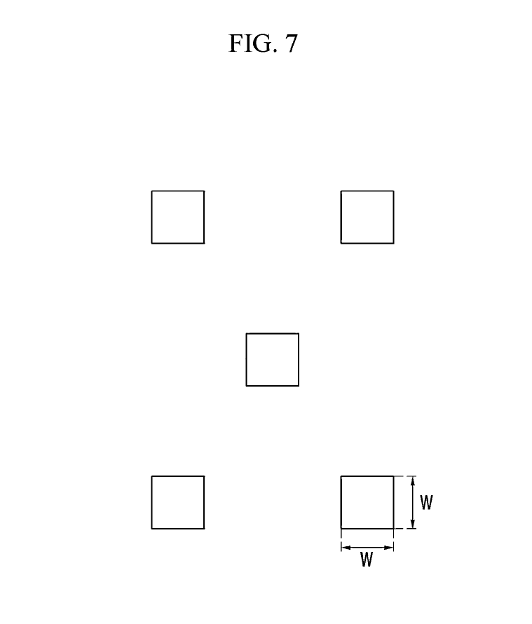

FIG. 1 is a cross-sectional view of a transparent liquid crystal display according to an exemplary embodiment of the present invention. FIG. 6 is a partial front view of a light guide according to an exemplary embodiment of the present invention. FIG. 7 is a partial front view of a light guide according to another exemplary embodiment of the present invention.

A liquid crystal display according to an exemplary embodiment of the present invention includes a display panel 1 including two display panels 100 and 200 facing each other and a liquid crystal layer 300 interposed therebetween, and a backlight module, which provides light to the display panel 1.

The backlight module includes a light source unit 20 and a light guide 10. The light source unit 20 includes a light source 22 and a printed circuit board (PCB) 21 mounting the light source 22, and as the light source 22, a dot light source, such as a light emitting diode (LED), or a linear light source, such as a cold cathode fluorescent lamp (CCFL), may be used. The light guide 10 includes a base plate material 14 having a plate shape and scattering particles 13 dispersed in the base plate material 14. A prism pattern 11 is formed in a bottom surface of the base plate material 14. The base plate material 14 may include a colorless transparent material that does not absorb a wavelength range of all visible rays, such as an acryl resin of polymethylmethacrylate (PMMA). The scattering particles 13 may be silicon beads. When a diameter of the scattering particles 13 is in a range of 2-4 μm, the scattering particles 13 may uniformly disperse the light from the light source while maintaining transparency of the light guide 10. When the diameter of the scattering particles 13 is less than 2 μm, a light scattering function is poor, and when the diameter of the scattering particles 13 is greater than 4 μm, the transparency of the light guide 10 may be deteriorated. When a width W of the prism pattern 11 is less than 10 μm, moiré interference is not generated in the liquid crystal display and a smooth image is displayed. A side cross-sectional (a cross-section parallel to a y-z surface) shape of the prism pattern 11 may be triangular, and a front cross-sectional (a cross-section parallel to an x-y surface) shape may take various shapes, such as quadrangular, circular, etc. FIG. 6 shows a prism pattern 11 having circular shape, and FIG. 7 shows a prism pattern 11 having rectangular shape. When the front cross-sectional shape of the prism pattern 11 is quadrangular, the width W of the prism pattern 11 is a length of one edge of the quadrangle, while when it is circular, the width W of the prism pattern 11 is the diameter of the circle. Accordingly, when the size of the prism pattern 11 is expressed as an area of the front cross-section and is less than 100 μm², the moiré interference is not generated and a smooth image is displayed in the liquid crystal display. When an interval P of the prism pattern 11 is in a range of 90-110 μm, the transparency of the light guide 10 and the light efficiency may be maintained. When the interval P is less than 90 μm, the transparency is deteriorated to such a degree that the image appears cloudy to eyes of the user, and when the interval P is greater than 110 μm, a light amount of the light reflected in the direction of the light emitting surface of the light guide among the light from the light source is insufficient such that the light efficiency of the light guide 10 is decreased and the brightness of the liquid crystal display is reduced.

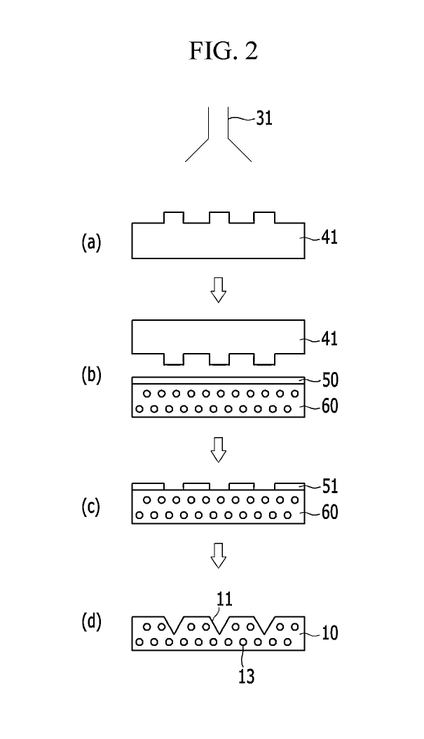

The prism pattern 11 having a width W of less than 10 μm (the area of the front cross-section is less than 100 μm²) may be formed by using an imprinting method. This method will be described with reference to FIG. 2.

FIG. 2 is a process view showing a manufacturing method of a light guide according to an exemplary embodiment of the present invention.

First, after a photosensitive film is coated on a hard stamp substrate, and the photosensitive film is patterned by using electron beam lithography, a hard stamp 41 is manufactured by using an etching method, such as reactive ion etching (RIE) (step (a)). In the hard stamp 41, a plurality of protrusions having a width of less than 10 μm and an interval therebetween 90-110 μm are embossed.

Next, a thermal hardening resin or a photo-hardening resin is coated on the base plate material 60 for the light guide dispersed with the scattering particle to form an imprinting object layer 50, and a hard stamp 41 is aligned thereon (step (b)).

Next, after the hard stamp 41 is pressed to the imprinting object layer 50 to form an imprinting shape, heat is applied or ultraviolet rays are irradiated to harden the imprinting shape, thereby forming an imprinting mask 51 (step (c)).

Next, the base plate material 60 for the light guide is etched by using the imprinting mask 51 as an etching mask to form a prism pattern, and the imprinting mask 51 is removed to complete a light guide 10 (step (d)).

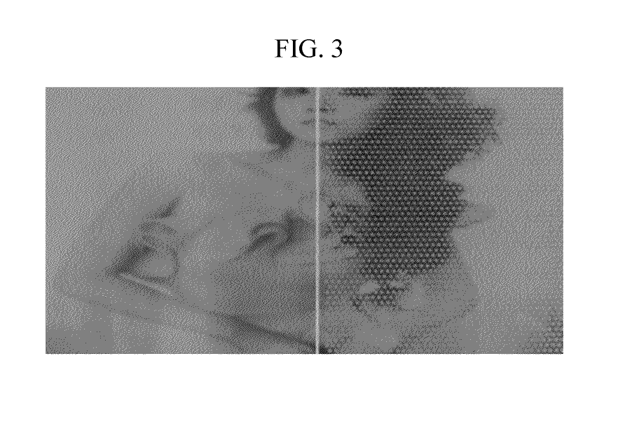

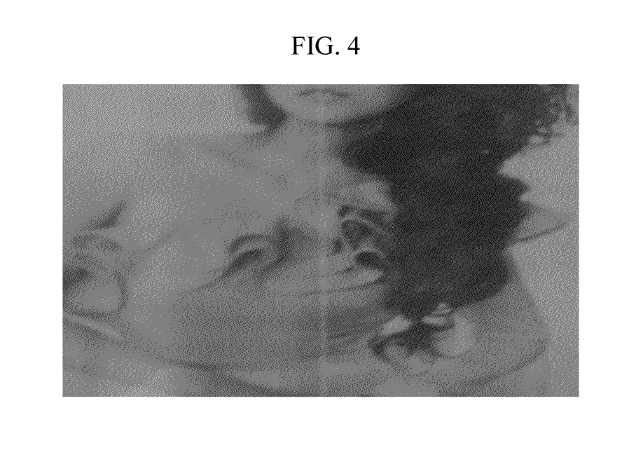

FIG. 3 shows an image display screen of a liquid crystal display using a general scattering particle type of light guide and a liquid crystal display using a general prism type of light guide, and FIG. 4 shows an image display screen of a liquid crystal display according to an exemplary embodiment of the present invention.

The left screen of FIG. 3 displays the image in a liquid crystal display having a light guide including only scattering particles, and the right screen displays the image in the liquid crystal display using a general light guide having a prism pattern having a width of more than 50 μm. In the case of the right screen, moiré interference is generated as a result of a mutual relation of the prism pattern of the light guide and the pixel size of the liquid crystal panel, and in the case of the left screen, although the moiré interference is not generated, the light efficiency of the light guide is low such that the brightness of the liquid crystal display is poor.

The left screen of FIG. 4 includes scattering particles and displays an image in the liquid crystal display using the light guide including the prism pattern with a width of 18 μm. The right screen includes scattering particles and displays the image in the liquid crystal display using the light guide including the prism pattern with the width of 6 μm. In the left screen, although a moiré interference is hardly generated, a clear definition of the image is decreased as compared with the right screen.

Referring to light extraction efficiency, the light guide including only the scattering particles has light extraction efficiency of 38.4%; the light guide having only the prism pattern having a width of 6 μm and a distance between the patterns of 100 μm has light extraction efficiency of 65.3%; and the light guide having the prism pattern having the width of 6 μm and a distance between the patterns of 100 μm together the scattering particles has light extraction efficiency of 70.1%. The light guide having the prism pattern with a width of less than 10 μm together the scattering particles may obtain light extraction efficiency of more than 60%. This is because the prism pattern reflects the light scattered by the scattering particles and dispersed in a direction other than that of the liquid crystal panel such that the reflected light returns in the direction of the liquid crystal panel, thereby reducing light loss. As described above, the light guide has a high light extraction efficiency such that the number of the light sources may be reduced and the cost may be reduced.

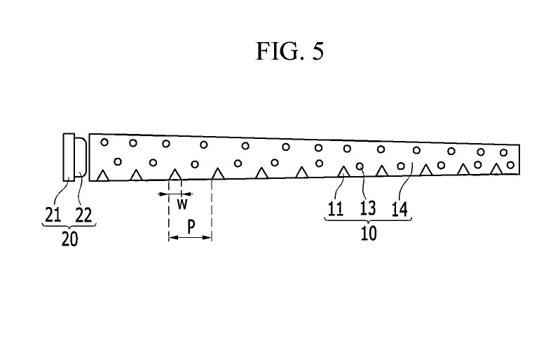

FIG. 5 is a cross-sectional view of a light guide according to another exemplary embodiment of the present invention.

FIG. 5 shows an exemplary embodiment of the present invention directed to a wedge-type light guide. Compared with the exemplary embodiment of FIG. 1, the thickness of the light guide 10 is decreased in a direction away from the light source 22, and the interval of the prism pattern 11 is narrowed in a direction away from the light source 22. The changed interval of the prism pattern 11 may be in the range of 90-110 μm. Also, the width W of the prism pattern 11 is less than 10 μm (the area of the front cross-section of the prism pattern 11 is less than 100 μm²), and the diameter of the scattering particles 13 is in the range of 2-4 μm.

A light guide including the scattering particles together with the prism pattern is described above. However, the scattering particles need not be included and the light guide having only the prism pattern with a width of less than 10 μm and a distance between the is patterns of 90-110 μm may be used.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A light guide comprising:
a light emitting surface; and
a reflection surface facing the light emitting surface and comprising a plurality of reflection patterns,
wherein the width of each of the plurality of reflection patterns is less than 10 μm.

2. The light guide of claim 1, wherein
an interval between the reflection patterns is in a range of 90-110 μm.

3. The light guide of claim 2, wherein
the reflection pattern comprises a prism pattern formed with a triangular shape in the reflection surface of the light guide.

4. The light guide of claim 3, further comprising
a plurality of scattering particles dispersed in a base plate material of the light guide.

5. The light guide of claim 4, wherein
the scattering particles comprise a bead shape and a diameter of 2-4 μm.

6. The light guide of claim 4, wherein
the base plate material comprises an acryl resin.

7. The light guide of claim 1, further comprising
a plurality of scattering particles dispersed in a base plate material of the light guide.

8. The light guide of claim 7, wherein
the scattering particles comprise a bead shape and a diameter of 2-4 μm.

9. A light guide comprising:
a light emitting surface; and
a reflection surface facing the light emitting surface and comprising a plurality of reflection patterns,
wherein an area of one front cross-section of the reflection pattern is less than 100 μm².

10. The light guide of claim 9, wherein
an interval between the reflection patterns is in a range of 90-110 μm.

11. The light guide of claim 10, wherein
the reflection pattern comprises a prism pattern formed with a triangular shape in the reflection surface of the light guide.

12. The light guide of claim 11, further comprising
a plurality of scattering particles dispersed on a base plate material of the light guide.

13. The light guide of claim 12, wherein
the scattering particles comprise a bead shape and a diameter of 2-4 μm.

14. The light guide of claim 12, wherein
the base plate material comprises an acryl resin.

15. The light guide of claim 9, further comprising
a plurality of scattering particles dispersed on a base plate material of the light guide.

16. The light guide of claim 15, wherein
the scattering particles comprise a bead shape and a diameter of 2-4 μm.

17. A method manufacturing a light guide, comprising:
forming an imprinting object layer on a base plate material having scattering particles dispersed therein;
pressing a hard stamp comprising a plurality of protrusions having a width of less than 10 μm to the imprinting object layer to form an imprinting shape, and hardening the imprinting object layer to form an imprinting mask; and
etching the base plate material by using the imprinting mask to form a prism pattern.

18. The method of claim 17, wherein
an interval between the protrusions of the hard stamp is in a range of 90-110 μm.

19. The method of claim 18, wherein
the imprinting object layer comprises a photohardening resin or a thermal hardening resin.
